(19) United States
(12) Patent Application Publication
(10) Pub. No.: US 2008/0091614 A1
(43) Pub. Date: Apr. 17, 2008

(54) Method To Make Payment Or Charge Safe Transactions Using Programmable Mobile Telephones

(75) Inventors: Fernando Bas Bayod, Zaragoza (ES); Jose Ignacio Bas Bayod, Zaragoza (ES); Francisco Bas Bayod, Zaragoza (ES)

Correspondence Address: THE CHAPAR FIRM, LLC, 945 BANK STREET, SUITE B, CONYERS, GA, 30012, US

(73) Assignee: Etrans LC, Miami, FL (US)

(21) Appl. No.: 11/658,950

(22) PCT Filed: Jul. 29, 2005
(86) PCT No.: PCT/ES05/70115

§ 371 Date: Jan. 29, 2007

(30) Foreign Application Priority Data
Jul. 30, 2004 (ES) P200401988

(51) Int. Cl. H04L 9/32; G06F 19/00

(52) U.S. Cl. 705/71

(57) ABSTRACT

This is a method to carry out safe transactions using programmable mobile telephones. The use of programmable handsets—for example with Java technology—, to which an application is downloaded (e.g. Java application) allows people to carry out safe transactions. The application allows the buyer/seller to carry out the transaction, including the verification, with just one connection. The data that was sent is then encrypted and transmitted via GPRS or any other data transmission protocol, to a transactions server, where the transactions are verified and authorised. The security of the process is provided mainly by the use of up to five non related identification elements, including an access key unique for each user, stored in the mobile handset.

### BACKGROUND OF THE INVENTION

The electronic payment is a method that has gained popularity throughout the time. There are numerous well known systems that allow making this type of payment.

At first, these systems were based completely on the traditional cable telephone communications and on magnetic band card readers placed in shops. But with the arrival of Internet and the mobile telephony, new methods of virtual payment have appeared. Specifically, there is a well known payment system by mobile telephone that is based in the association of a credit/debit card number with a PIN and a mobile telephone number in the transactions server. The procedure followed by the system is, basically, the authorisation of the operation by the user, once the transaction data received in his mobile phone. The transaction is not complete until the user confirms it with his mobile phone, introducing his secret PIN. The communication with the user, in order to authorise such transaction, is done via a data call from the transactions server, which will take control of the introduction of data with the keypad and the representation of the information on the telephone screen. When buying at the merchant's site, a specially configured POS is required, in order to pay with this system, because the transaction must start with a special call to a telephone number, call that is handled by the transactions server.

This system suffers from rigidity, due to the fact that the communication with the user is done via a data call, which makes it difficult for the system to be worldwide spread, and therefore it will be necessary to have transaction servers in each country. On the other hand, due to the fact that the system needs to take control of the mobile handset, and this control depends on the different mobile phone brands and models, and since that control is not standardised, it will be necessary to have different modules for each different mobile phone, and also for each new model, which will make it even less universal. Moreover, the user will be forced to learn new instructions every time he uses a different model. A connection via the WAP protocol, which allows a bigger standardisation, will make the process a lot more expensive for the user, due to the large quantity of data required in the connections using this method and the lack of flexibility of the WML languages. On the other hand, the limited keypad of the mobile phone affects the introduction of the required alphanumeric data, in a WAP connection, what makes the transaction process slower, in the case of using the mobile handset as a phone for purchasing/selling. Finally, the own conception of the system requires the presence and use of POS terminals in the shops.

### BRIEF SUMMARY OF THE INVENTION

The present invention can be framed in the technical sector of telecommunications and is about a valid method for telephones based on programmable mobile handsets with a connection to Internet, for charge and payment transactions, in which the use of up to 5 elements of verification of the user by the system, makes such transactions safe. The 5 elements used by the system to identify the user can be: 1) the debit/credit card data, or debit bank account; 2) the users mobile telephone number (TEL); 3) the user's personal identification number PIN (NIP); 4) the user's SIM card information that the mobile handset sends as identifier when it connects to internet, currently through HTTP headers (SIM), information that can be read by the transactions server; and 5) an access key (CA) that the applications server assigns to the new user, being this access key saved in the mobile telephone memory and also in the transactions server database.

Also, the use of a specific application downloaded into the handset allows that the introduction and sending of data, the authorisation of the transaction and its verification by the user be made with the minimum number of connections and in a simple way, which makes the system more flexible. The universality of the application, also, allows the system to be used with any mobile telephone without having to make any changes, in any country and using any mobile phone operator with a service access to Internet. Also, the use of a specific application and the robustness and safety of the system allows the seller to receive payments without any card reading devices or any other auxiliary elements being used, other than his own mobile phone. On the other hand, the buyer does not need to have his mobile phone when he is purchasing, since the seller's mobile phone can be used, as said, to process the entire transaction.

The system to which the method is applied consists of a transactions server and several programmable mobile handsets, to which an application (eg. written in Java) has been previously downloaded. The purchasing application is designed to make payments, being mainly used in virtual shopping transactions (for example, payments in virtual shops or vending machines). The user introduces the shopping data and sends it to the server, for this to validate the transaction.

The selling application has bed designed to make charges at the seller's site, and it has been made as a substitute for the POS (Point Of Sale) systems. In this case, it is the seller who initiates the application, enters the shopping data, and invites the client to enter his telephone number. Once this number is entered, it is sent to the transactions server to obtain the information to identify the client, from the database and sends it to the application that has been downloaded into the mobile handset. The application receives the data and shows them to the seller, for him to verify, by means of his PIN, that it belongs to the client. Afterwards, these identification data plus the sales' data are shown to the buyer, for him to verify and confirm it by introducing his PIN. Finally, all the compiled information is sent to the server for the verification of the transaction.

Before the mobile handset can be used as a terminal for purchasing or selling, it is necessary for the application to be configured with the security and identification information of the user—his access key (CA), his fixed encryption key (CF) and the mobile telephone number (TEL)—, which were stored in the transactions server during the registration process of the user. For this, the user needs to enter his secret information only once—user name (ID) and password (CONT)—in the designed fields. This configuration process is done automatically, after the correct identification of the user in the system. This automatic configuration confers a great robustness, security and simplicity of use of the system, since it transfers the secret data following a sophisticated encryption outline, which establishes an essential difference with the existing payment methods.

The registration of the user in the system, which can also be processed via a human registering operator, can be carried out via the user accessing a WEB page on the transactions server, where he introduces the necessary personal and identification data, as well as the credit/debit card or bank account information. In a preferred execution of the invention, in the case of using the mobile telephone, number as identifier, this is verified and authenticated after by the user, by sending a short message SMS to the transactions server. In case of using the user's SIM card HTTP header, as well, as identifying element, this could be identified by an HTTP connection to that server, connection which could be done at the same time the user downloads the application to the mobile handset, if the mobile phone operator includes that HTTP header in the connection. In both identification ways, by telephone number and SIM HTTP header, the transactions server takes the telephone number from the short message SMS, or the SIM information from the HTTP headers, or both, and after validating all the identification data, and credit/debit cards or bank accounts, stores all the information in its database, for a later identification of the registered user.

The invention can be used in several transactional payment applications, like mobile telephone recharges, instant payment to goods supply companies, parking ticket machines, sport bets, money transfers between users, money recharges in Smart Cards, and in general for every transaction that requires a safe identification of the user.

### BRIEF DESCRIPTION OF THE DRAWINGS

FIG. 1 shows a preferred execution of the patent to make purchasing/selling transactions.

FIG. 2 shows a preferred execution of the user registration process in the system.

FIG. 3 shows a preferred execution of the download process of the application into the mobile handset

FIG. 4 shows a preferred execution of the configuration process of the application, which has been downloaded to the mobile handset

FIG. 5 shows a preferred execution of the mode selection process

FIG. 6 shows a preferred execution of a purchasing transaction

FIG. 7 shows a preferred execution of a selling transaction.

### DETAILED DESCRIPTION OF INVENTION

In order to improve the above mentioned systems, a new method has been devised to make charge/payment transactions with a safe identification and authorisation of the users, using a mobile handset, with the following features:
1) User friendly: since the handsets that make the purchasing/selling transactions are the users' own mobile phones. The mobile phones are programmable and must be downloaded with a specific application (e.g. written in Java), downloaded by the user from an applications server, or from another type of data storage, like for example a computer equipped with disks readers; or must be pre-loaded with the application by the manufacturer of the phone.

The application also contains automatic configuration software, by means of which the phone will access, in an encrypted way, the secret and identification users data (access key (CA), the fixed symmetric encryption key (CF) and the telephone number (TEL) used in the system), kept in the transactions server, and it will store them in the phone's memory, with a minimum user interaction.
2) Security: The systems' security is achieved due to the complete user's verification, using up to 5 significant elements (ES) of non related information, or of difficult relation, like a) personal data and credit/debit card information, or other financial accounts data, b) the personal identification number PIN (NIP), c) the mobile phone number, d) the HTTP headers of the SIM card information, sent by the mobile handsets, and e) an access key (CA), assigned to each user by the transactions server and stored in the mobile phone's memory when it downloads the application, or in the later configuration.
3) Flexibility: the system's flexibility is due to the fact that all the data to be entered in a transaction can be numeric, which allows a comfortable introduction using the mobile phone keypad. Likewise, since the system is based on an application that can be downloaded by the user in a remote way, the future incorporation of other services or improvements will only need the user's participation by downloading again the application to the mobile phone, without the need of a new configuration.
4) Universality: This is due to the use of a specific application in the mobile phone, which can be remotely downloaded by the user, to any mobile phone with Internet access, which allows the mobile phone to be used as a transactions terminal for purchasing/selling in any country and using any mobile phone operator. There is not need for any intervention either, on the mobile phones or SIM cards, by these phones' manufacturers.
5) Cost: The transactions cost for the user or for the transactions server administrator company is minimum, since once the application is downloaded to the mobile phone, it allows an optimum data flow between the mobile handset and the transactions server.

Purchasing Application

In a preferred execution of the purchasing application invention, the buyer will enter in the designed fields, in the application which has been downloaded to the mobile handset, the amount to be paid (CANT), the personal identification number PIN (NIP), the salesman's telephone number (TELV) (shown in the vending machine, or in the virtual or real shop) and the shopping reference number (REF). The application, which has been downloaded to the mobile phone, adds automatically the user's phone number (TEL) and the access key (CA) to the data which has already been entered, both taken from the mobile telephone's memory, it then generates a symmetric encryption session key (CS), different for each connection, using the cryptography module and it encrypts those data—except the user's own telephone number (TEL)—with that session key. Afterwards it encrypts the generated session key (CS), with the fixed symmetric encryption key (CF), which is found in the mobile phone's memory, it adds the result to the data to be transmitted, and it sends them to the transactions server. The transactions server will receive the encrypted data, it will de-encrypt the session key (CS) with the fixed encryption key (CF) corresponding to the user referenced by the received telephone number (TEL), and finally it will de-encrypt the rest of the data with the session key (CS) obtained. The data process is therefore:

Telephone:

CA, CF, TEL=Obtain them from the telephone's memory

User enters CANT, TELV, NIP, REF

CS=Obtain it with Cryptographic Module

DATA={CA, CANT, TELV, NIP, REF}

ENCRYPTED_DATA=Encrypt (DATA with CS)

CS_ENCRYPTED=Encrypt (CS with CF)

FINAL_DATA={ENCRYPTED_DATA, CS_ENCRYPTED, TEL}

Send FINAL_DATA

Transactions Server

Receive FINAL_DATA

TEL=Obtain it from FINAL_DATA

SIM=Obtain it from the SIM HTTP header

CF=Obtain it from the Database (using TEL/SIM)

CS_ENCRYPTED=Obtain it from FINAL_DATA

CS=De-encrypt (CS_ENCRYPTED with CF)

DATA=De-encrypt (ENCRYPTED_DATA with CS)

Another option would be to use the protocol SSL or SSH, in which case it would not be necessary to generate fixed encryption keys (CF) for each user, nor the session keys (CS), being such encryption/de-encryption process automatically done by the system.

Once the operation is validated, by checking the user's identity, credit availability and the existence of a valid product reference (for virtual purchases) for this transaction, the user will receive a message of acceptance, including the account balance.

Selling Application

In a preferred application of the invention for the selling application, the seller enters in the designed fields in the application, which has been downloaded to the handset, the amount to be charged (CANT) and optionally the sales reference number (RV). The buyer enters then his mobile telephone number (TELC), which Was allocated to the transactions system, in the field shown in the application. This number is then sent to the transactions server, for this to recover and send the buyer's identification data.

This data is encrypted using the fixed encryption key (CF) corresponding to the user and sent to the telephone. The application, which has been downloaded to the mobile handset, will de-encrypt the data with the fixed encryption key (CF) recovered from the phone memory and will show them so they can be validated by the seller, by introducing his signature PIN (NIPV) in the designed field in the downloaded application. Once this is entered, the application will show again the buyer's identification data, as well as the shopping information, and will request that the buyer validates the transaction by introducing his signature PIN (NIPC) in the corresponding field of the downloaded application. After the introduction of his PIN, the downloaded application will recover the access key (CA) and the salesman's own telephone number (TEL) from its memory and will add them to the entered data. The downloaded application will generate then a session symmetric encryption key (CS) and will encrypt all the entered data—except the seller's telephone (TEL)—, with it. Later on, it will recover the fixed symmetric encryption key (CF) from the telephone's memory, will encrypt the session key (CS) with it, and will add it to the data to be sent. Finally this data is sent to the transactions server. The server will recover the fixed encryption key (CF) corresponding to the salesman by means of his mobile telephone number (TEL), will de-encrypt the session key (CS) using that fixed key (CF), and finally it will de-encrypt the rest of the received data using that fixed key (CF). The data process is therefore:

Telephone:

CA, CF, TEL=Obtain them from the telephone's memory

Seller enters CANT, RV

Buyer enters TELC

Send TELC

Transactions Server:

Receive TELC

Clients data identification, CF=C Obtain from the Database (using TELC)

ENCRYPTED_DATA=Encrypt (Client's identification data with CF)

Send ENCRYPTED_DATA

Telephone:

Receive ENCRYPTED_DATA.

Identifying_data=De-encrypt (ENCRYPTED_DATA with CF)

Visualize identifying_data

The seller enters NIPV

The buyer enters NIPC

CS=Obtain it with Cryptographic Module

DATA={CA, CANT, TELC, RV, NIPV, NIPC}

ENCRYPTED_DATA=Encrypt (DATA with CS)

CS_ENCRYPTED=Encrypt (CS with CF)

FINAL_DATA={ENCRYPTED_DATA, CS_ENCRYPTED, TEL}

Send FINAL_DATA

Transactions Server:

Receive FINAL_DATA

TEL=Obtain it from FINAL_DATA

SIM=Obtain it from the SIM HTTP header

CF=Obtain it from the Database (using TEL/SIM)

CS_ENCRYPTED=Obtain it from FINAL_DATA

CS=De-encrypt (CS_ENCRYPTED with CF)

DATA=De-encrypt (ENCRYPTED_DATA with CS)

SSL o SSH protocols could be also applied in this case.

Once the operation is validated by the transactions server, both mobile handsets, the seller's and the buyer's will receive, each one a message of the operation acceptance, including the balance information in their respective accounts.

In a preferred embodiment of the invention, in both applications, the purchasing one and the selling one, the transactions server reads the HTTP headers content (in these headers each SIM card is identified), and the received data are de-encrypted as previously explained, using all that information to identify the users implicated in the transaction, and finally to carry out the transaction or to deny it. The operation, once validated, will consist of a money transfer between the allocated user's account and the seller's account, both identified by the HTTP headers generated by the mobile telephone for each SIM card, or by their mobile phone's numbers or by both at the same time. Both applications (purchasing and selling), can be included, for economy and uniformity reasons, in one application, so the user will select in the application's menu the operating mode for purchasing or selling, which can be configured by the user in order to operate in one of these modes.

Configuration of the Application Downloaded into the Phone

As previously said, the configuration of the mobile phone is done automatically before the mobile handset can be used to make transactions. The security data CF, TEL and optionally CA are sent to the application. It is for this that, the user must introduce his name (ID) and password (CONT) only once, just as they were stored into the transactions server database, in the user's registration process. The application, which has been downloaded to the mobile handset, initiates the connection with the transactions server, which, after the connection, generates a couple of asymmetric encryption keys, via the cryptography module. The public key (CPUB) is sent to the mobile phone via the open channel and the private one (CPRIV) is stored in the server, as a session variable. The application, which has been downloaded to the mobile handset, generates at the same time a session symmetric encryption key (CS), and it encrypts this key together with the identification data (ID) and (CONT), which have been previously entered, with the received public key (CPUB). Finally it sends this information to the transactions server. This recovers the private key (CPRIV), de-encrypts the data sent with this key, it recovers the user's data (fixed symmetric encryption key (CF), user's telephone (TEL) and, optionally, the access key (CA)) from the database, using the identification information received, it encrypts this data with the session symmetric key (CS) also received, and sends the resultant information to the mobile phone. The application on the mobile phone receives the information, it de-encrypts it using the session symmetric key (CS), and stores the resultant data in the telephone's memory. The access key (CA) could be not sent in this configuration process, being then sent in the application download, as it is explained later on.

The data process is therefore:

Telephone:

User enters ID, CONT

Initiate Server connection

Transactions Server:

CPUB, CPRIV=Obtain them with Cryptographic module

Send CPUB

Telephone:

Receive CPUB

CS=Obtain it with Cryptographic Module

DATA={ID, CONT, CS}

ENCRYPTED_DATA=Encrypt (DATA with CPUB)

Send ENCRYPTED_DATA

Transactions Server:

Receive ENCRYPTED_DATA

Recover CPRIV

DATA=De-encrypt (ENCRYPTED_DATA with CPRIV)

ID, CONT, CS=Obtain from DATA

CA, CF, TEL=Obtain from the Database (using ID, CONT)

DAT={CA, CF, TEL}

ENCRYPTED_DAT=Encrypt (DAT with CS)

Send ENCRYPTED_DATA

Telephone:

Receive ENCRYPTED_DAT

DAT=De-encrypt (ENCRYPTED_DAT with CS)

CA, CF, TEL=Obtain from DAT

Store CA, CF, TEL

User's Registration

In the registration process, which is carried out in a web page, the user's personal and financial data (DAT) are entered, amongst which is the user's mobile telephone number (TEL), which is verified by reading a short message (SMS) sent by the user to the server, in the registration process; and the telephone SIM card (SIM) information, read on the HTTP header sent by the telephone operator, in the case of this being effectively sent, (specifically the header “tm_user_id” for the Spanish mobile phone operator Movistar). Also the secret data is generated: the access key (CA) and the fixed key (CF). Furthermore the user enters an identifying phrase, used for the verification of the system's authenticity when the application operates in selling mode. All that data is stored in the database, in a record with the mobile phone number and/or the SIM information as references. The data process is as follows:

Web Page:

The user introduces his personal identity and financial data.

TEL=Obtain it from the SMS

SIM=Obtain it from the mobile Operator (HTTP connection with the mobile)

CA, CF=Obtain them with Cryptographic Module

{Personal Data, TEL, SIM, CA} store in the database (using TEL)

The scope and contents of the present invention will be shown with more clarity with drawings, which demonstrate a preferred execution of it, where:

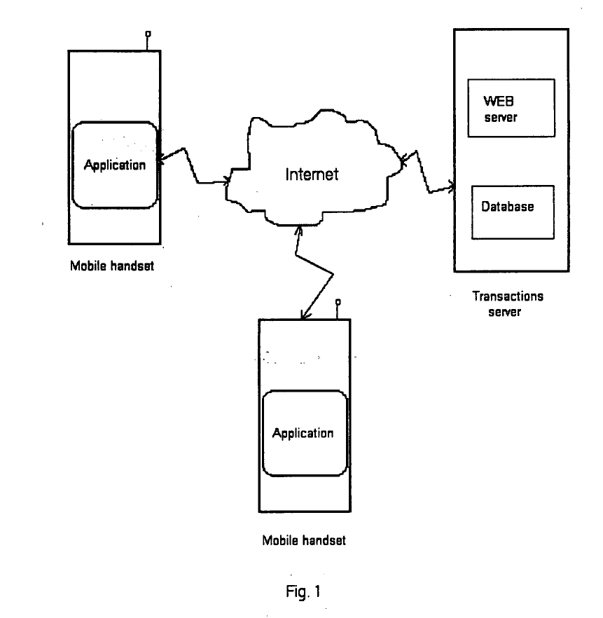

In FIG. 1 you can see several mobile phones loaded with the application, which allows them to transmit the user's identification data to the transactions server, for this to verify and validate the transactions. Also, the application will allow them to receive and visualize the results of the last transactions made.

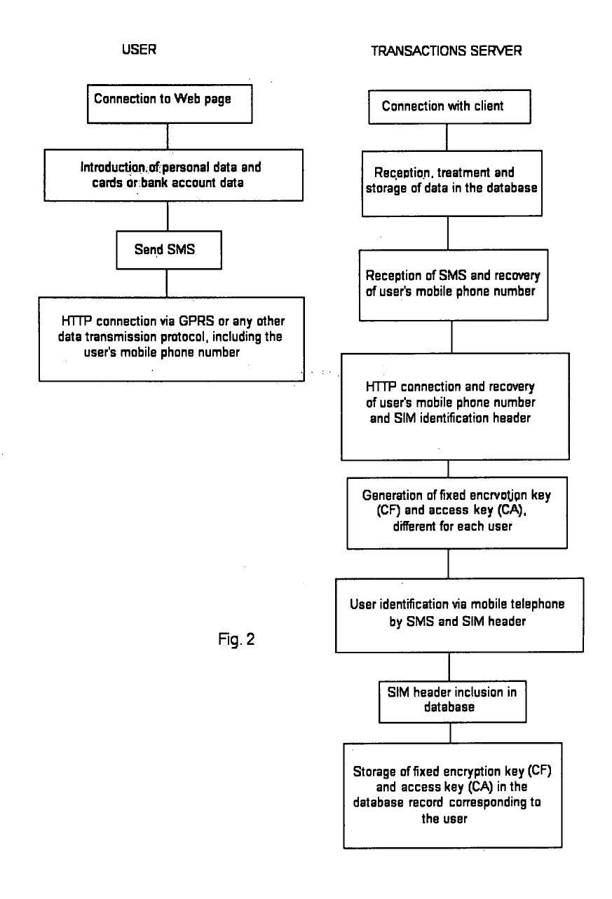

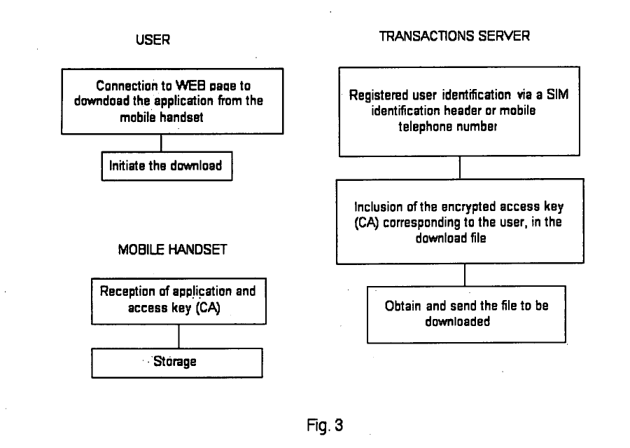

In order for the system to be able to be used, it will be necessary for the user to register on it. In FIG. 2 you can see how the user starts the registration process on the transactions server. This registration, as it can be seen in the preferred execution, can be carried out on a web page designed for this, and it involves the introduction of the personal identification data, including an identifying phrase, and the credit/debit card or financial accounts information. The identifying phrase allows the user to check the authenticity of the seller's application, making it very difficult for this application to be manipulated in a fraudulent way, when it is used on the sales mode. Later, the user sends a SMS (short message) to the transactions server. The server reads the SMS and takes the mobile phone number (TEL), checking and verifying this number with the user's data that has already been entered. The use of the telephone number strengthens the security, and also simplifies the users identification, who will not need to memorise unnecessary and complex information. Finally, the user, by using a mobile phone with the same SIM card with which he has sent the previous SMS, makes an HTTP connection to a URL on the server, sending his telephone number (TEL) with this connection. The transactions server reads the HTTP header, specific to the identification of the user's SIM card, and the phone number (TEL), and adds this information to the data that have already been compiled. Finally it stores all this information in the database record with the user's telephone number (TEL) as a reference. In the same process, the server generates a fixed encryption key (CF), associated to each user, and it stores it in the database, in the record associated to each user. Finally, the transactions server will generate an access key (CA) different for each user and will store it as well in the database record. Once this process if finished, the user can download the application into his mobile phone, as it can be seen in FIG. 3, simply by getting into a server URL address and initiating the download, the transactions server can read the HTTP header related to the user's SIM card identification and his telephone number (TEL) mentioned before. In the preferred execution, the transactions server can read the access key (CA) associated with the user, encrypt this information with the fixed symmetric encryption key (CF) and add it to the file to be downloaded, together with the actual application, in a way that could be safely read and manipulated by this application. In the case of a Java application, this encrypted key (CAE) will be added to the Manifest File or to the Descriptor File of the .JAR container as an application's property. Finally, the file will be downloaded to the mobile phone. The attached information to the application (CAE) is automatically stored in the mobile telephone's memory so it can be used later. This information will be read later and de-encrypted by the application, each time the user initiates a transaction, using the fixed symmetric encryption key (CF), in order to obtain the access key (CA). The fact that the access key (CA) is sent encrypted in the same application which has been downloaded, gives security to the process, since the downloaded file o files are completely inaccessible for the malicious hackers.

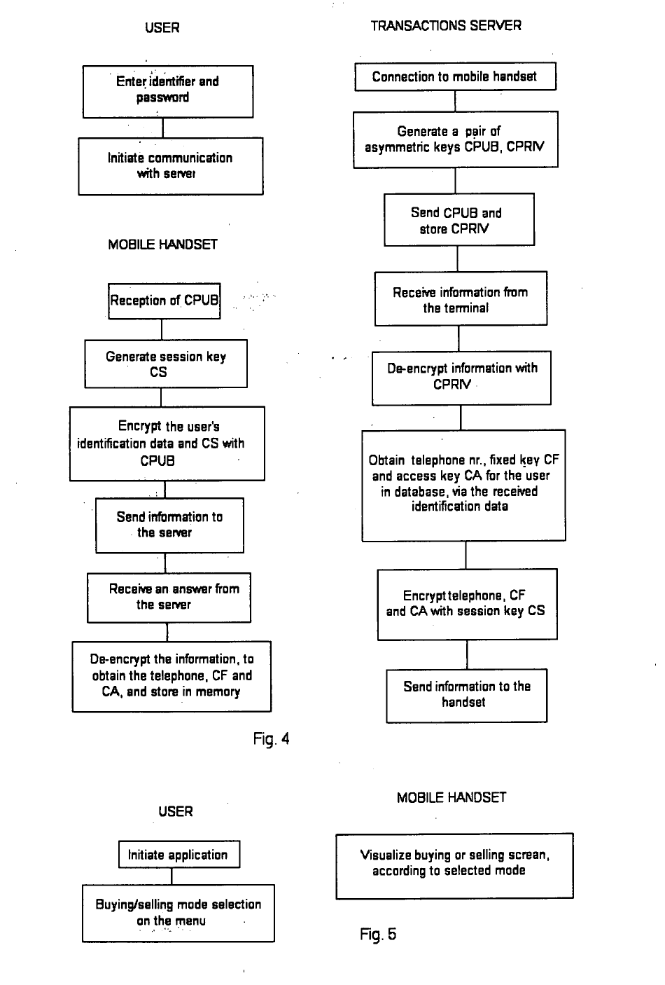

As previously said, once the application has been installed on the mobile phone, it will be automatically configured with the users secret information, consisting of the fixed symmetric encryption key (CF), the user's telephone number (TEL) and, optionally, the access key (CA), which could have been directly obtained in the application's download. For that purpose, the downloaded application shows a screen to introduce data, where the user will be asked for his system identification nick (ID) and his password (CONT). The accessible menu only provides configuration start and help options. After introducing the (ID) and (CONT) data, the user will initiate the configuration process. Next, the mobile handset will connect to the transactions server, being the configuration process carried out as previously explained. Once the configuration is complete, the mobile handset will be ready to carry out transactions. This process can be seen in FIG. 4.

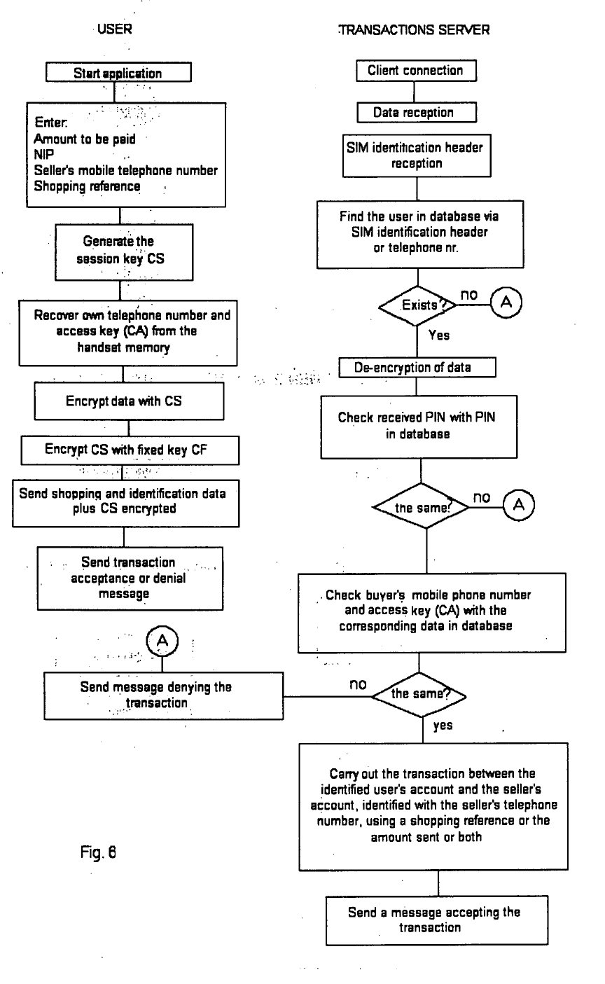

Once the application has been configured, the user can access the menu, in which there are several options. The following are amongst them: (1) mode selection, (2) start transaction, and (3) transactions verification. In the FIG. 5 it can be seen how the application allows you to configure the mobile handset in either the PURCHASING or the SELLING mode with the option (1).

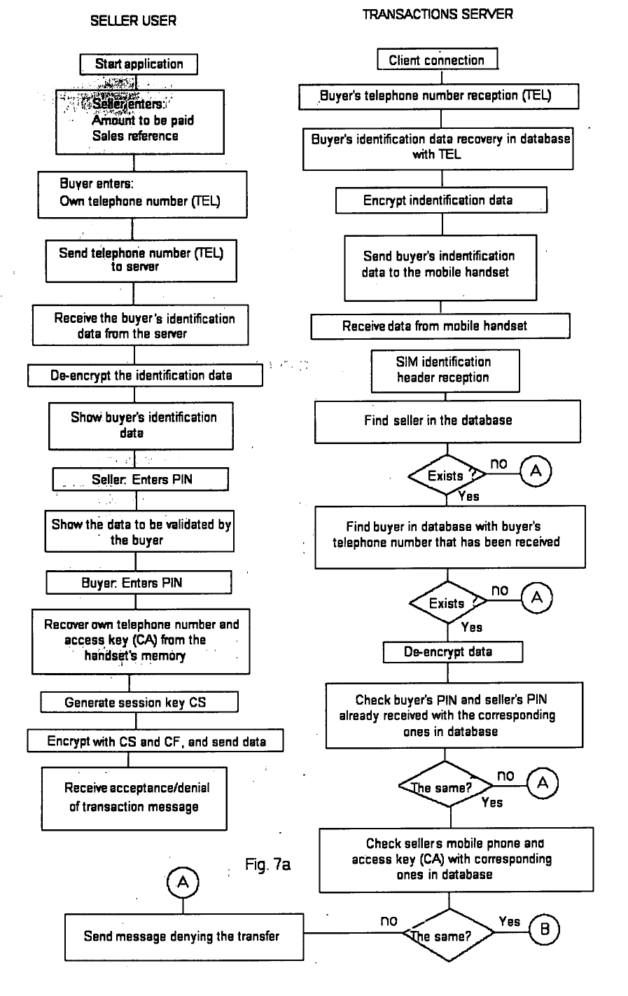

To initiate a purchasing transaction, the user will need to initiate the configured application on PURCHASING mode. As it can be seen in FIG. 6, when you choose this mode, the application shows 3 empty fields in which the user must introduce the amount to be paid, the personal identification number PIN and the salesman's telephone number. It also shows a field for the purchase reference (RC), the use of it is optional, for either give details of the shopping or to introduce the reference allocated by the electronic shop. Once the data is introduced, the application gets the access key (CA) and the mobile telephone number (TEL) from the mobile handset's memory, and they are all encrypted by the application according to the process previously explained, and sent via GPRS, UMTS or any other cellular protocol of data transmission, to the transmission server over Internet. In the FIG. 6 it can be seen how the application gathers and encrypts the data and how the server receives this data encrypted, as well as the SIM card identification HTTP headers. Once the data have been received, the transactions server gains access to the associated database, where it carries out the search for the record being identified by the corresponding HTTP header, or by the user's own telephone number (TEL), which is sent without being encrypted. If such record does not exist, the transaction will be finished, sending a message to the user in that sense, using the connection which is still open. If the register exists, the information that has been received is de-encrypted as explained before, and the personal identification number PIN (NIP) sent will be compared with the existing one in the database. If they do not coincide, the transaction will be finished, sending a warning message to that effect to the user via the established connection. If they coincide, the access key (CA) sent will be next compared with the existing one in the database. Finally, the seller's phone (TELV) will be checked in the data base for existence. If one of the checks fails, the transaction will finish, sending the corresponding warning message. If all the data coincides, the transaction will be considered correct. In this case, the transference of funds will be carried out, from the account associated to the referred user in the identified record to the account that belongs to the user who's reference is the seller's mobile phone number (TELV), previously introduced by the buyer and sent by the mobile handset, and either corresponding to the purchase introduced in the optional purchase reference field (RC), which was sent previously from the mobile handset, or quantified by the amount field of the transaction (CANT), sent as well from the mobile handset. Once the transfer has been carried out, it will be considered complete, and a confirmation message will be sent to the user, using the same connection, which is still open, and encrypted using the session key (CS). This message will show the most relevant information of the transaction. The transactions server will keep a record of all the transactions made by the system, whether they are correct or incorrect. The SSL protocol could be used, in this case, in a similar way, and the previously mentioned encryption would not be necessary.

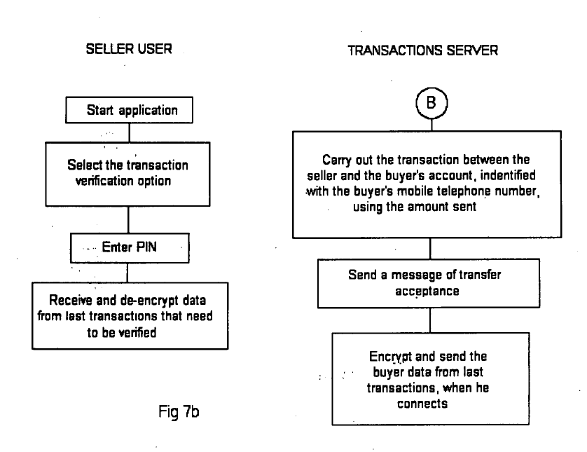

The FIG. 7 shows the process followed for a selling transaction. In this case, the seller must initiate the application and select the SELLING mode on the menu. After doing this, he will get a screen with two fields, relating to the transaction amount (CANT) and the sales reference (RV). The second field is optional. Once this information is introduced and accepted, the application will show another screen where it is required that the buyer enters his user telephone number (TELC). After this being entered and validated, the mobile handset will connect to the transactions server and will communicate the telephone number (TELC), with which the server recovers the buyer's identification information: the name, the identification number (e.g. Identification Number or passport number) and the identifying phrase which was entered in the registration process. These data are encrypted as explained previously and sent to the mobile handset. The name, the user's identification number and the identifying phrase are de-encrypted and the first two are shown to the seller for them to be verified. This will be carried out by the introduction of his signature PIN (NIPV). Immediately the name, the buyer's identification number, the identifying phrase and the amount to be paid are again visualized, and the buyer is asked to verify this information with his signature PIN (NIPC). Once the verification process is complete, the application adds to the shopping data (CANT, RV, NIPV, NIPC, TELC), the access key (CA), taken from the telephone's memory, it encrypts this information as previously explained, and adds to it the seller's telephone (TELV). The application connects then to the transactions server via a GPRS, or UMTS connection or any other data transmission protocol, and sends the information. The server receives, then, certain seller's and buyer's encrypted information, the seller's telephone number, as well as the SIM card's identification HTTP headers. The transactions server de-encrypts then the information as explained before and checks if the record referenced by the corresponding HTTP header (or by the salesman's own telephone number TELV), as well as the buyer's record, referenced by his telephone number (TELC), exist in the database. If one of these records does not exist, that transaction finishes, sending a message of error to the seller's handset, via the connection, which is still open. If the buyer's personal identification number PIN, once de-encrypted, does not coincide with the PIN which is associated to the buyer's record through his mobile phone number (TELC) sent in the connection, the transaction finishes, and again a message of error is sent to the seller's mobile handset. If both PIN coincide, the seller's mobile telephone number associated to the identification HTTP header, the key access (CA) and the seller's identification number PIN (NIP) will be read from the database. If this information coincides with the one which has been recently de-encrypted, belonging to the seller, the transaction is considered correct and the funds transfer, between the buyer's account, referenced by his mobile telephone number (TELC), and the salesman account, referenced by the corresponding HTTP header (or by his mobile telephone number TELV), is carried out. The transactions server keeps a record of all the transactions made whether they are valid or not, including the sales reference (RV) attached, if this has been entered by the seller in his mobile handset. A confirmation message will be sent to the seller's mobile handset, using the still open connection, previously encrypted with the session key (CS). If any of the users want to know later the last transaction's result, he must use the option (3) in this transaction menu. Once this option is selected, he must introduce his personal identification number PIN (NIP). The application encrypts this information in the same way as in the purchasing process and it adds the user's own telephone number (TEL), to it. Finally it connects with the transactions server and sends this information. The transactions server receives the SIM card identification HTTP header, or in other case, the user's mobile telephone number (TEL), reads the record associated to this user from the database, checks that both PIN's coincide, generates the confirmation message, it encrypts it with the session key (CS), in the same way as in the purchasing process, and sends it to the mobile phone. The application de-encrypts the confirmation message and shows it on the mobile phone's screen. In this case the SSL safe protocol could be used in the same way.

The system could be provided with better security, by blocking the user's record when three wrong connections with the same identification HTTP header (or the same telephone number) are made.

It will also be possible to pay for a service, which due to its nature, does not need for the seller to be registered on the system. For example for charging mobile telephones and Smart cards. In these cases, the application, which has been downloaded to the mobile phone, will not request the buyer to introduce and send the seller's telephone number, since the seller's identification is implicit in the service request. Therefore, in these situations, all the steps described here for the purchasing application are applicable, except the one for sending the seller's telephone number. Instead of this information, it will be sent a service identification parameter. Otherwise, the description of these cases does not differ from what has been exposed.

Naturally, the invention is not limited to the above executions, described and shown in the figures, since it can be modified within the scope of the attached claims.

1. A method to carry out purchasing/selling transactions of the kind of those that use mobile phones, in which the improvement comprises the utilization of Programmable mobile handsets (e.g. with Java technology) which converts a programmable mobile handset (e.g. with Java technology) into a purchasing/selling terminal, at the users choice, by downloading, in a remote way, an application to that effect, and later automatically and safely configuring that application with the secret and identifying data, referred to the user, and that comprises the steps of:
a) Registration of the user, storing up to 5 significant elements (ES), amongst them the SIM card information included in the HTTP corresponding header sent by the mobile phone operator, in the transactions server database; constituting these elements the users main information. In this registration process, a fixed symmetric encryption key (CF) and an access key (CA) will be generated as well, being they different for every user. This step is carried out by each user only once and can be done in a virtual (via internet) or non-virtual way. The data are stored in the transactions server database.
b) The download of a specific application (e.g. written in Java) into the user's mobile phone, including the access key (CA) encrypted by the server with the fixed symmetric encryption key (CF), in order to convert the user's mobile handset in a safe purchasing or selling terminal, this download been done via a WEB server hosted by or connected to a transactions server, and this will apply for each user once.
c) To configure automatically the application that was downloaded to the mobile phone by: 1. encryption and download to the mobile handset of the user's own telephone number (TEL), the fixed encryption key (CF), and optionally, the access key (CA), all of them unique for each user and generated by the transactions server, for them to be used by the application in every transaction done. This step is carried out only once by the transactions server and 2. De-encryption and storage in the mobile telephone, of the user's own mobile telephone number (TEL), the fixed symmetric encryption key (CF), and optionally, the access key (CA), previously downloaded. This step will be automatically carried out by the application, which was downloaded to the mobile phone and it will be carried out only once
d) To initiate the application that has been downloaded to the mobile handset. This process will be carried out by the user, using the means supplied by the programmable mobile telephone, controlled by the application, each time the user wants to make a transaction.
e) To select the operation mode on the mobile handset: PURCHASING mode or SELLING mode, in the downloaded application menu designed for this purpose. This step is carried out by the user using the means supplied by the programmable mobile handset and by the application.
f) To carry out purchasing and selling transactions.

2. A method as in claim 1, further comprising the following steps for the PURCHASING mode in order to carry out a purchasing transaction.
a) To introduce the seller's telephone number (TELV), the personal identification number PIN (NIP), the amount to be paid (CANT), and the shopping reference (RC), if any, in the corresponding fields generated by the downloaded application. This step will be carried out by the user, using the means supplied by the programmable mobile handset, controlled by the application running on it, each time the user wants to make a purchasing transaction.
b) To recover the mobile telephone number (TEL), the access key (CA) and the fixed symmetric encryption key (CF), from the telephone's memory. This step will be carried out automatically by the application (written in Java, for example), which was downloaded to the mobile handset.
c) To generate a session key (CS) via the application cryptography module (written in Java, for example), which was downloaded to the mobile phone. This step is carried out automatically by the application (written in Java, for example) on the mobile phone.
d) To encrypt these data (TEL, CANT, NIP, RC, CA), except the buyer's mobile telephone number (TEL), with the session key (CS). This step will be carried out automatically by the cryptographic module of the mentioned application (written in Java, for example), which was downloaded to the mobile phone.
e) To encrypt the session key (CS) with the fixed encryption key (CF). This step will be carried out automatically by the cryptographic module of the application, which was downloaded to the mobile phone.
f) To connect with the transactions server. This step will be carried out automatically by the mentioned application (written in Java, for example), which was downloaded to the mobile phone, between this phone and the transactions server.
g) To send the compiled and encrypted data (TELV, CANT, NIP, RC, CA, CS) to the transactions server. This step will be carried out by the application (written in Java, for example), via a GPRS, UMTS connection or any other Internet connection protocol.
h) To receive the compiled data, plus the SIM card identification header of the connected user's mobile handset. The transactions server will carry out this step automatically.
i) To use the SIM card identification header, or the buyer's mobile phone number (TEL), to find the corresponding records for the users involved in the transaction. The transactions server will carry out this step automatically.
j) To de-encrypt via the CF and CS keys, and process the rest of the data in order to check the correct identity of the users against the information already stored on the database. The transactions server will carry out this step automatically.
k) To validate and carry out (in that case) the transaction between the buyer and the seller, using the data: NIP, CA, TELV. The transactions server will carry out this step automatically.
l) To encrypt and send a confirmation message to the user's mobile phone which will be connected. This step will be carried out automatically by the transactions server between this transactions server and the user's mobile handset connected to it, via a GPRS, UMTS connection or any other Internet connection protocol.
m) To keep a record of the transaction. The transactions server will automatically carry out this step.
n) To encrypt and send to the salesman's mobile handset and at his request, a report of the last transaction. This step will be carried out automatically by the transactions server between this transactions server and the user's mobile phone connected to it, via a GPRS, UMTS connection or any other Internet connection protocol.

3. A method according to claim 1, in which the mobile phone, which has been downloaded with the application (written in java, for example), can be used to carry out safe selling transactions, at the user's choice, on selling mode.

4. A method as in either claim 1 or claim 3, in which the following steps will be followed to carry out a selling transaction on the selling mode:
a) To enter the amount to be charged (CANT) and, in that case, the sales reference (RV), This step is carried out be the seller, using the means supplied by the programmable mobile telephone, controlled by the application, which has been downloaded to it, each time a sales transaction is carried out.
b) To enter the buyer's telephone number (TELC) in the corresponding field. This step is carried out by the buyer, using the means supplied by the programmable mobile telephone, controlled by the application downloaded to it, each time a sales transaction is carried out.
c) To receive the mobile telephone number and recover the buyer's identification information from the database, with that telephone number as a reference (TEL). This step is automatically carried out by the transactions server.
d) To encrypt and send this information with the fixed encryption key (CF). The cryptographic module of the transactions server carries out this step automatically.
e) To receive and de-encrypt the buyer's identification information with the fixed encryption key (CF). This step will be automatically carried out with the application, which was downloaded to the mobile phone.
f) To show the buyer's identification information to the seller. This step will be automatically carried out by the application, which was downloaded to the mobile phone.
g) To validate the identification data by entering the signature PIN (NIPV). The seller using the means supplied by the mobile phone and the application, which was downloaded to it, carries out this step.
h) To show both the identification and the information related to the transaction, to the buyer. This step will be automatically done by the application, which was downloaded to the telephone.
i) To validate the data by introducing the signature PIN (NIPC). The buyer using the means supplied by the mobile phone and the application, which was downloaded to the telephone, carries out this step.
j) To recover the seller's mobile telephone number (TELV) and the access key (CA) from the mobile telephone's memory. This step will be automatically carried out by the application (written in Java, for example), which was downloaded to the mobile phone.
k) To generate a session key (CS) via the cryptography module of the application (written in Java, for example) downloaded to the mobile phone. This step will be automatically carried out by the application (written in Java, for example), which was downloaded to the mobile phone.
l) To encrypt this data (TELC, NIPC, NIPV, CA, CANT, RV) with the session key (CS). This step will be automatically carried out by the application (written in Java, for example) which was downloaded to mobile phone.
m) To encrypt the session key (CS) with the fixed encryption key (CF). The cryptographic module of the application, which was downloaded to the mobile phone, carries out this step automatically.
n) To connect to the transactions server. This step will be automatically carried out by the mentioned application (written in Java, for example), which was downloaded to the mobile phone, between this phone and the transactions server.
o) To send the compiled data (TELC, NIPC, NIPV, CA, CANT, RV, CS) to the transactions server. This step will be automatically carried out by the application (written in Java, for example), which was downloaded to the mobile phone, between this phone and the transactions server, via a GPRS, UMTS connection or any other Internet connection protocol.
p) To receive the compiled data, plus the SIM card identification header of the mobile phone connected to the transactions server. The transactions server will automatically carry out this step.
q) To use the SIM identification header, and/or the users' mobile telephones, in order to find the corresponding records for the users involved in the transaction. The transactions server will automatically carry out this step.
r) To de-encrypt and process the rest of the information via the CS and CF keys, in order to check the users' correct identities, against the information stored in the database. The transactions server will automatically carry out this step.
s) To validate the NIP, NIPV and CA data and to carry out, given the case, the transaction between the buyer and the seller. The transactions server will automatically carry out this process.
t) To encrypt and send a confirmation message to the seller's mobile handset. This step will be automatically carried out by the transactions server between this transactions server and the user's mobile handset connected to it, through a GPRS, UMTS connection or any other internet connection protocol
u) To keep a record of the transaction. The transactions server will automatically carry out this step.
v) To encrypt and send to the buyer's handset, at his own request, a report of the last transaction. This step will be automatically carried out by the transactions server between this transactions server and the user's mobile handset connected to it, via a GPRS, UMTS connection or any other Internet connection protocol.

5. A method according to claim 1, in which step b) can also be carried out by downloading the application from any data storing device, once the user has been registered, or it can be downloaded by the telephone's manufacturer.

6. A method according to claim 1, in which the configuration process of the application, that has been downloaded to the phone, is carried out following the below mentioned steps:
a) The user introduces his identification data (ID) and (CONT) in the corresponding fields shown by the application, which was downloaded to the mobile phone.
b) The user initiates a connection to the transactions server.
c) The transactions server generates a couple of asymmetric encryption keys public (CPUB) and private (CPRIV)
d) The transactions server sends the public key CPUB to the application downloaded in the mobile phone, and stores the private key CPRIV as a session's variable.
e) The application, which was downloaded into the mobile phone, generates a session encrypted key (CS).
f) The application, which was downloaded into the mobile phone, encrypts ID, CONT and CS with the public key (CPUB).
g) The application which was downloaded into the mobile phone, sends the encrypted data to the transactions server
h) The transactions server recovers the private key CPRIV and de-encrypts the received data with it.
i) The transactions server uses ID and CONT to recover the identification data (TEL) and the safety data (CA) and (CF) from the database. CA could be not sent in this process.
l) The transactions server encrypts this data with the session encryption key CS.
k) The transactions server sends this data to the mobile phone.
l) The application, which was downloaded into the mobile phone, receives the data and de-encrypts them using the session key (CS).
m) The application, which was downloaded into the mobile phone, stores this data in the mobile phone memory.

7. A method to carry out purchasing/selling transactions using programmable mobile phones (e.g. with Java technology), which can also be used to make transactions in which the seller for this service is not registered on the system. In these cases the seller's telephone number is not sent to the transactions server, and a parameter of the service is sent instead.
